(19) United States
(12) Patent Application Publication
(10) Pub. No.: US 2009/0253418 A1
(43) Pub. Date: Oct. 8, 2009

(54) System for conference call and corresponding devices, method and program products

(76) Inventor: Jorma Makinen, Tampere (FI)

Correspondence Address: HARRINGTON & SMITH, PC, 4 RESEARCH DRIVE, Suite 202, SHELTON, CT, 06484-6212, US

(21) Appl. No.: 11/921,207

(22) PCT Filed: Jun. 30, 2005
(86) PCT No.: PCT/FI2005/050264

§ 371 Date: Nov. 28, 2007

(51) Int. Cl. H04M 3/42; H04M 1/00

(52) U.S. Cl. 455/416; 455/569.1

(57) ABSTRACT

The present invention concerns a system for a conference call, which includes: at least one portable audio device (MEM2-MEMn) arranged in an common acoustic space (AS) which device (MEM2-MEMn) is equipped with audio components (LS2-LSn, MIC2-MICn) for inputting and outputting an audible sound and at least one communication module (22); at least one base station device (MA) to which at least the said one portable audio device is interconnected and which base station device is connected to the communication network (CN) in order to perform the conference call from the said common acoustic space. At least part of the portable audio devices are personal mobile devices which audio components (MIC2-MICn) are arranged to pick the audible sound from the said common acoustic space.

The invention concerns system for a conference call, which includes
at least one portable audio device arranged in an common acoustic space which device is equipped with audio components for inputting and outputting an audible sound and at least one communication module,
at least one base station device to which at least the said one portable audio device is interconnected and which base station device is connected to the communication network in order to perform the conference call from the said common acoustic space.
   In addition, the invention also concerns a corresponding devices, method and program products.

A conference call should be easy to set up and the voice quality should be good. In practice, even expensive conference call devices suffer from low voice quality making it difficult to follow a discussion. A typical meeting room is usually equipped with a special speakerphone. The distance between the phone and participants might vary from a half meter to few meters. Many of the current voice quality problems are due to the long distance.

If a microphone is placed far from an active talker, the talker's words might be hard to understand as the reflected speech blurs the direct speech. In addition, the microphone becomes sensitive for ambient noise. It is possible to design a less reverberant room and silence noise sources such as air conditioning, but such modifications are expensive. Furthermore, the long distance from the loudspeaker to an ear may decrease the intelligibility of the received speech.

The strength of a sound can be described by Sound Pressure Level L₍ₚ₎ (SPL). It is convenient to measure sound pressures on a logarithmic scale, called the decibel (dB) scale. In free field, sound pressure level decreases 6 dB each time the distance from the source is doubled. Lets assume a meeting room has a high quality speakerphone and the distances between the phone and the participants A_{NEAR}, B_{NEAR}, C_{NEAR} and D_{NEAR} are 0, 5 m, 1 m, 2 m and 4 m. In case of equally loud participants and approximately free field conditions, the sound pressure level may vary 18 dB at the common microphone.

Because of such high differences, some people sound too loud and some too quiet. The situation gets even worse if, in addition to the near-end, also the far-end participants are using a speakerphone and the distances between the far-end participants and the speaker vary. By assuming similar conditions, the far-end participants may perceive up to 18 dB differences in the loudspeaker volume. Therefore, without microphone level compensation, the perceived sound pressure levels might vary up to 36 dB.

It is possible to use an automatic level control to balance the speech levels of the microphone signal. At best, the level control provides only a partial solution to the voice quality problem. Even a perfect level control cannot address problems caused by reverberant room acoustic and environmental noise. The effect of these problems might actually increase when the level control amplifies the microphone signal to balance the speech levels. If the meeting room has even noise field, the noise level of the balanced signal increases 6, 12 or 18 dB when the distance from the microphone increases from 0, 5 m to 1, 2 or 4 m. Because the gain is adjusted according to an active participant, the noise level of the transmitted signal will vary.

In practice, level control algorithms are not perfect. When speech levels between participants vary a lot, it becomes difficult to discriminate between silent speech and background noise. There may be delays in the setting of the speech level after a change of an active speaker. On the other hand, fast level control may cause level variation. Furthermore, a level control algorithm cannot balance the speech levels of several concurrent speakers.

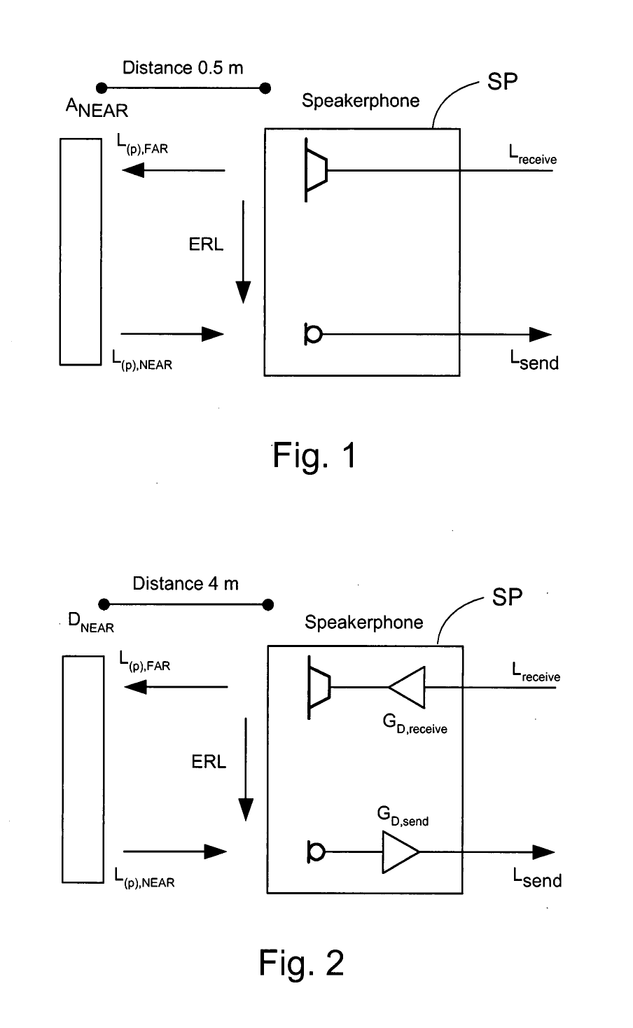

Many of the trickiest voice quality problems in current systems relate to echo. When the distance between a participant and the speakerphone increases, disturbances like residual echo, clipping during double talk or non-transparent background noise become harder, if not impossible, to solve. FIG. 1 illustrates a meeting room arrangement the participant A_{NEAR} being positioned close to the speakerphone SP. The receive signal level L_{receive} produces a comfortable sound pressure level L_{(p),NEAR}, to the participant A_{NEAR}. Respectively, a normal speech level of A_{NEAR}, corresponding to sound pressure level L_{(p),NEAR}, produces a desired level L_{send} on the send direction. The Echo Return Loss (ERL) describes the strength of echo coupling. The level of the echo component on the send direction can be determined in dB as L_{echo}=L_{receive}−ERL.

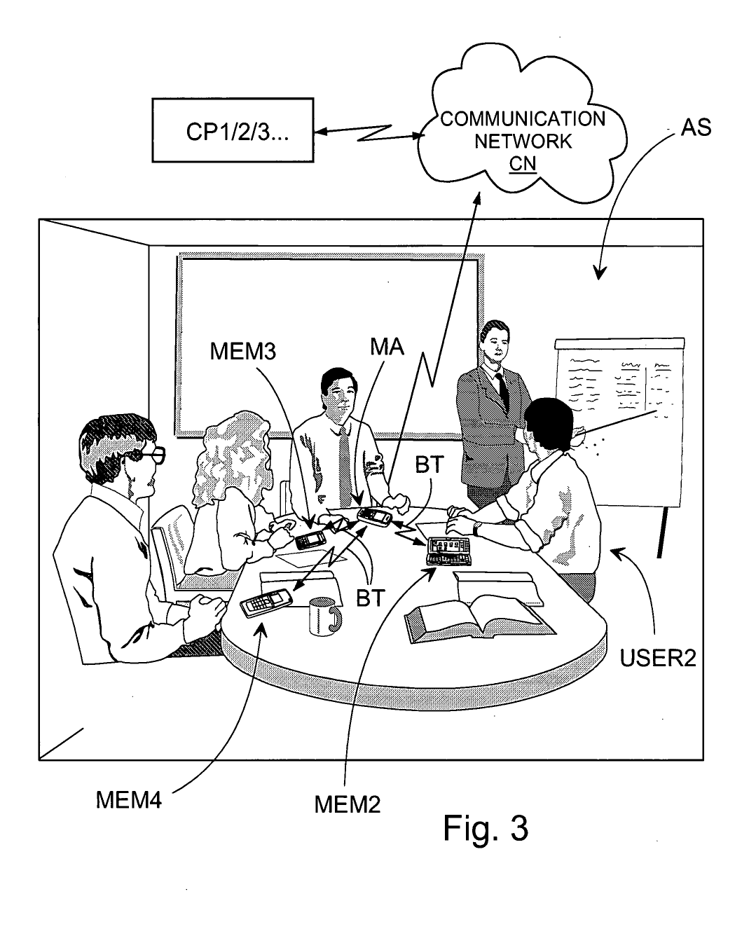

FIG. 2 illustrates a meeting room arrangement the participant D_{NEAR} being positioned far from the speakerphone SP. The receive signal level L_{receive} must be increased by G_{D,receive}=18 dB to produce a comfortable sound pressure level L_{(p),FAR} to the participant D_{NEAR}. Respectively, a normal speech level of D_{NEAR}, corresponding to sound pressure level L_{(p),NEAR}, must be increased by G_{D,send}=18 dB to produce the desired level L_{send} on the send direction. The gains G_{D,receive} and G_{D,send} compensate the attenuation of far and near speech due to the longer distance. The ERL does not change. However, the level of the echo component on the send direction is now considerably higher L_{echo}=L_{receive}+G_{D,receive}−ERL+G_{D,send}.

To illustrate the effect of long distances, it may be observed a case where the levels of the transmitted far and near speech components are set to an equal value, preferable to the nominal value of the network. A typical echo control device contains adaptive filter and residual echo suppressor blocks. The adaptive filter block calculates an echo estimate and subtracts it from the send side signal. The suppressor block controls the residual signal attenuation. It should pass the near speech but suppress the residual echo. To enable both duplex communication and adequate echo control, the level of residual echo should be at least 15-25 dB below the level of near speech. Depending on speaker phone design and used adaptive techniques, typical ERL and Echo Return Loss Enhancement (ERLE) values are 0 dB and 15-30 dB. The ERLE denotes the attenuation of echo on the send path of an echo canceller. In this description, the ERLE definition excludes any non-linear processing such as residual signal suppression.

If the setup of FIG. 1 is observed, it may be noted that the level of the residual echo component is L_{echo}=L_{receive}−ERL−ERLE. By assuming ERL of 0 dB and ERLE of 30 dB, the level becomes L_{echo}=L_{receive}−0 dB−30 dB=L_{receive}−30 dB. As the levels of the transmitted far and near speech components were balanced, it may be seen readily that the level of the residual echo is 30 dB below the level of the near speech making it possible to have duplex communication and sufficient echo control.

If it is considered the setup of FIG. 2, it may be noted that the level of the residual echo is L_{echo}=L_{receive}+G_{D,receive}−ERL+G_{D,send}−ERLE. By assuming ERL of 0 dB and ERLE of 30 dB, the level becomes L_{echo}=L_{receive}+18 dB−0 dB+18 dB−30 dB=L_{receive}+6 dB. As the levels of the transmitted far and near speech components were balanced, it may be seen readily that the level of the residual echo is 6 dB above the level of the near speech making it impossible to have duplex communication and sufficient echo control.

Some prior arts are also known from the field of conference calls. U.S. Pat. No. 6,768,914 B1 provides full-duplex speakerphone with wireless microphone. This solution applies a wireless microphone to increase the distance between the loudspeaker and the microphone and to decrease the distance between the microphone and participants. Single microphone, loudspeaker and echo control are known from this.

U.S. Pat. No. 6,321,080 B1 presents conference telephone utilizing base and handset transducers. This has the same idea than just described above, activate the base speaker and the handset microphone or vice versa.

U.S. Pat. No. 6,405,027 B1 describes group call for a wireless mobile communication device using Bluetooth. This solution is applicable only to group call, not to conference call in which there are several participants in a common acoustic space. In a group call loudspeaker signals include contributions from all other devices. This solution replaces a traditional operator service rather than a speakerphone.

Preferable, also conference call meetings would be nice to be arranged anytime and anywhere, for instance in hotel rooms or in vehicles. Arranging of a conference call should also be as easy as possible. In many respects, voice quality and mobility set contradictory requirements to the pieces of conference call equipment. For instance, to provide an adequate sound pressure level for all participants, a relatively large loudspeakers should be arranged. Also, in mobile use, the sizes of devices need to be minimized.

The purpose of the present invention is to bring about a way to perform conference calls. The characteristic features of the system according to the invention are presented in the appended claim 1 and the characteristic features of the devices are presented in claims 13 and 20. In addition, the invention also concerns a method and program products, whose characteristic features are presented in the appended claims 31, 43 and 49.

The invention describes a concept that improves the voice quality of conference calls and also makes it easy to set up a telephone meeting. The invention replaces a conventional speakerphone with a network of personal mobile audio devices such as mobile phones or laptops. The network brings microphones and loudspeakers close to each participant in a meeting room. Proximity makes it possible to solve voice quality problems typical in current systems. Traditional conference call equipment is not needed in meeting rooms. This opens new aspect in order to implement conference calls in different kind of environments.

According to the invention, several microphones may be used to pick the send side signal. According to the second embodiment of the invention, several loudspeakers can be used to play the receive side signal. According to the third embodiment of the invention, speech enhancement functions of the send side signal may be distributed to the personal mobile devices.

According to the fourth embodiment of the invention, speech enhancement functions that modify dynamically the loudspeaker signal occur mainly on the master device. According to the fifth embodiment of the invention at minimum, the network may transfer the at least one microphone signal of one or more active speaker. The master may determine this from the received measurement information in order to dynamically select at least one microphone as an active one.

Owing to the invention, numerous advantages to arrange conference calls are achieved. A first advantage is achieved in voice quality. Owing to the invention the voice quality is good because the microphone is close to the user. In addition, the voice quality is also good because the loudspeakers are close to the user.

In addition, the voice quality is good because of distributed speech enhancement functions. These functions can adapt to local conditions. Yet one more advantage is that now the meetings can be organized anywhere. This is due to the fact that now people may use their own mobile phones and special conference call equipment is not anymore needed.

Other characteristic features of the invention will emerge from the appended Claims, and more achievable advantages are listed in the description portion.

The invention, which is not limited to the embodiments to be presented in the following, will be described in greater detail by referring to the appended figures, wherein

FIG. 1 shows speech and echo levels when speakerphone according to prior art is close to the user,

FIG. 2 shows speech and echo levels when speakerphone according to prior art is far from the user,

FIG. 3 shows an application example of the conference call arrangement according to the invention,

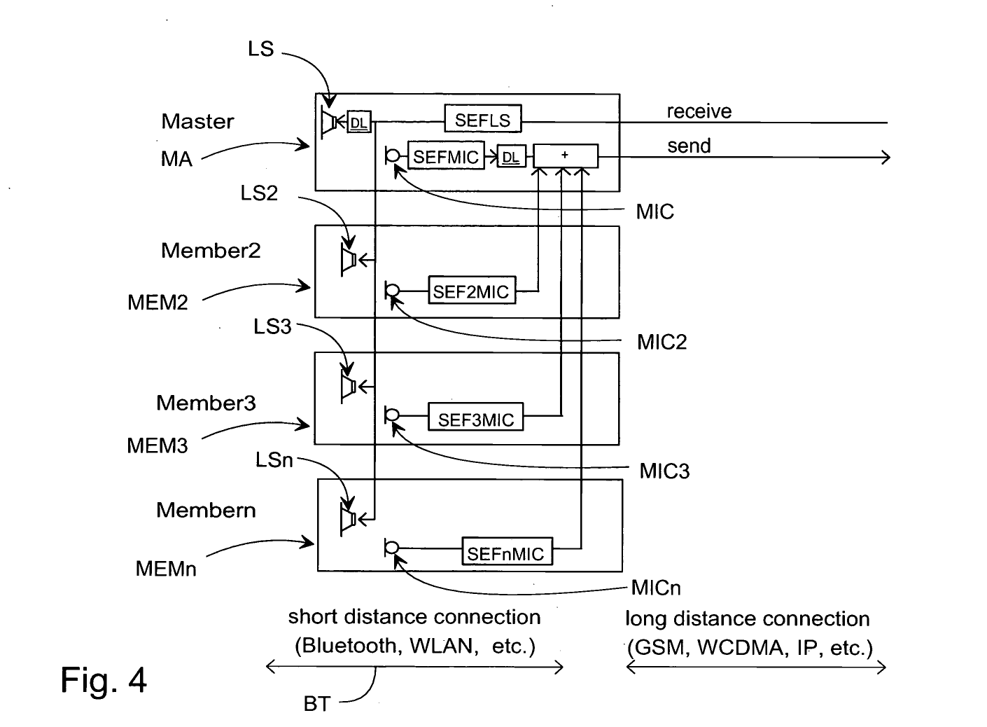

FIG. 4 is a rough schematic view of a basic application example of the multi-microphone and -loudspeaker system,

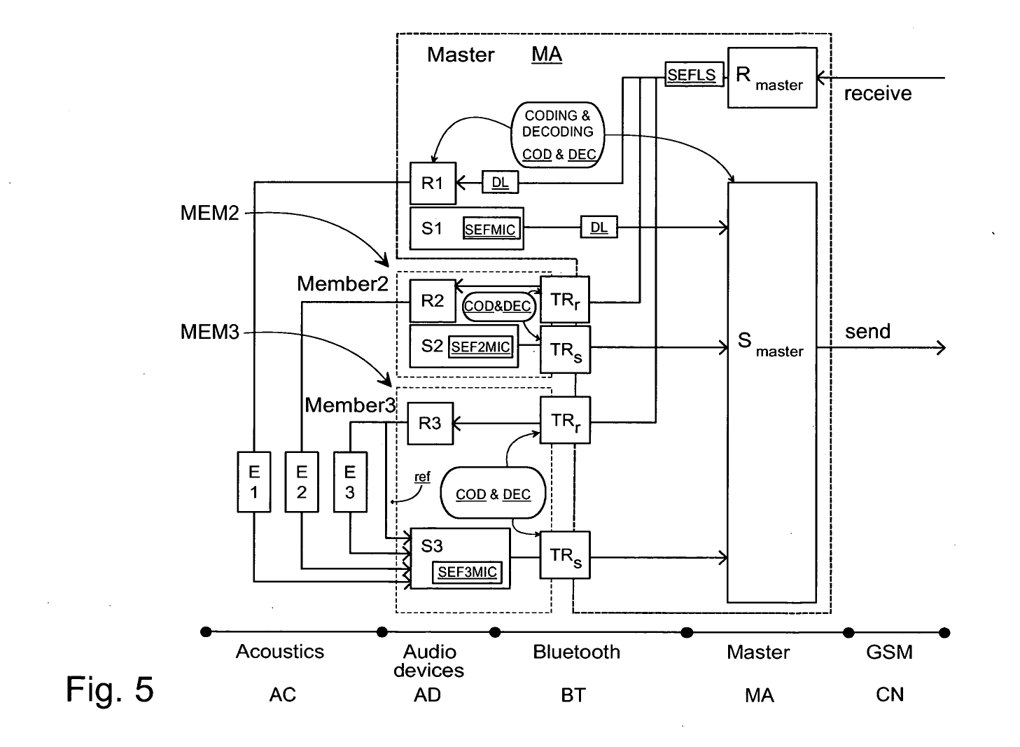

FIG. 5 is an application example of processing blocks and echo paths from member 3 point of view in multi-microphone and -speaker system according to the invention,

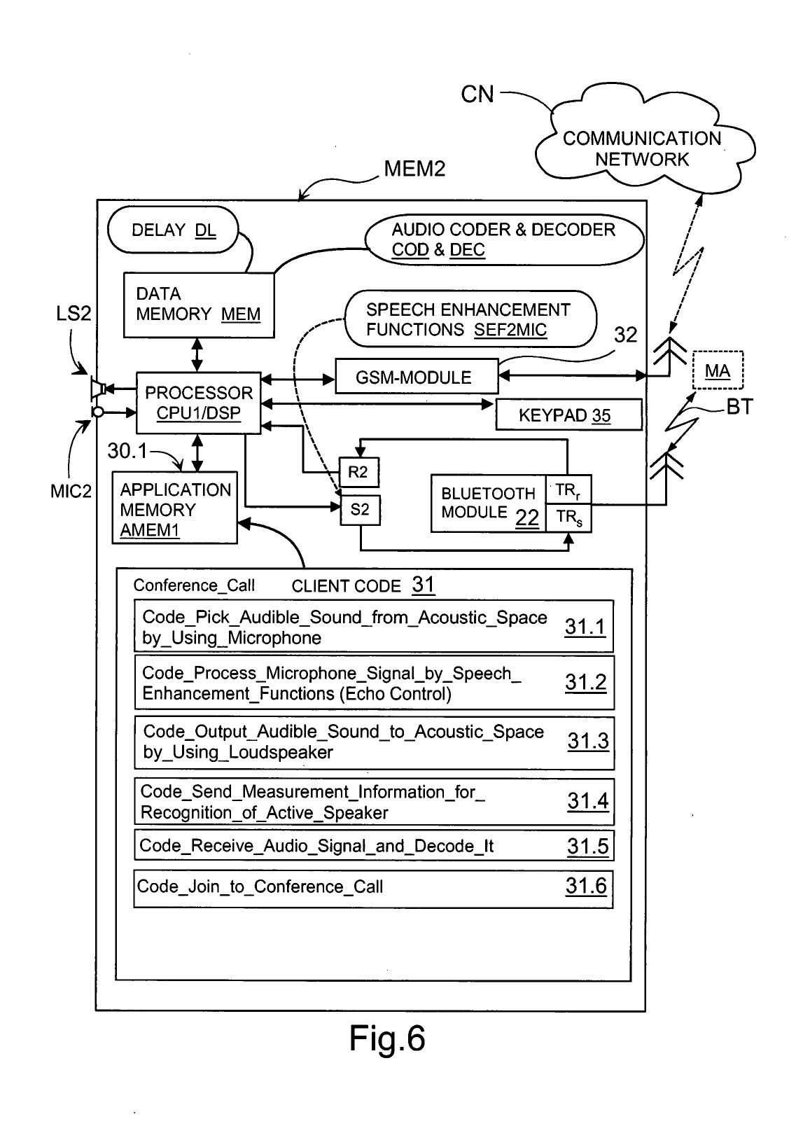

FIG. 6 is a rough schematic view of a basic application example of the personal mobile device and the program product to be arranged in connection with the personal mobile device according to the invention,

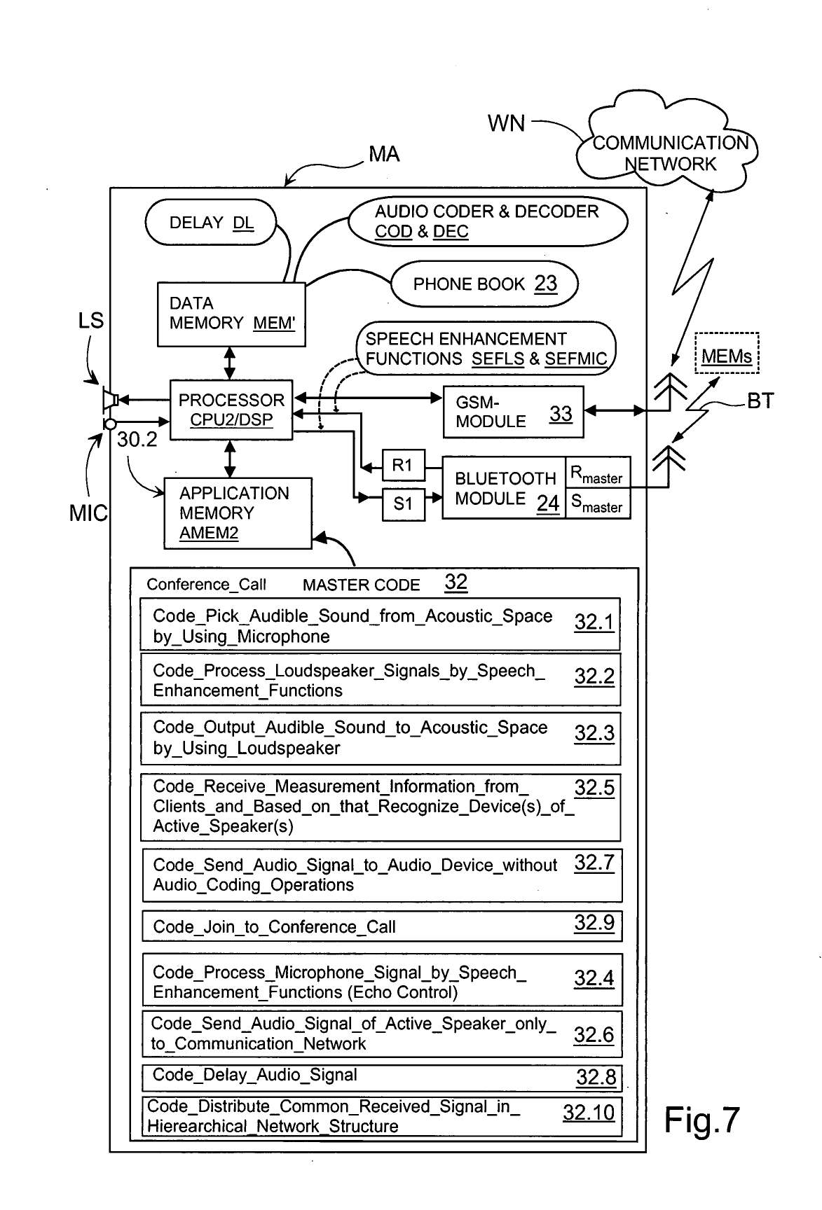

FIG. 7 is a rough schematic view of a basic application example of the base station device and the program product to be arranged in connection with the base station device according to the invention and

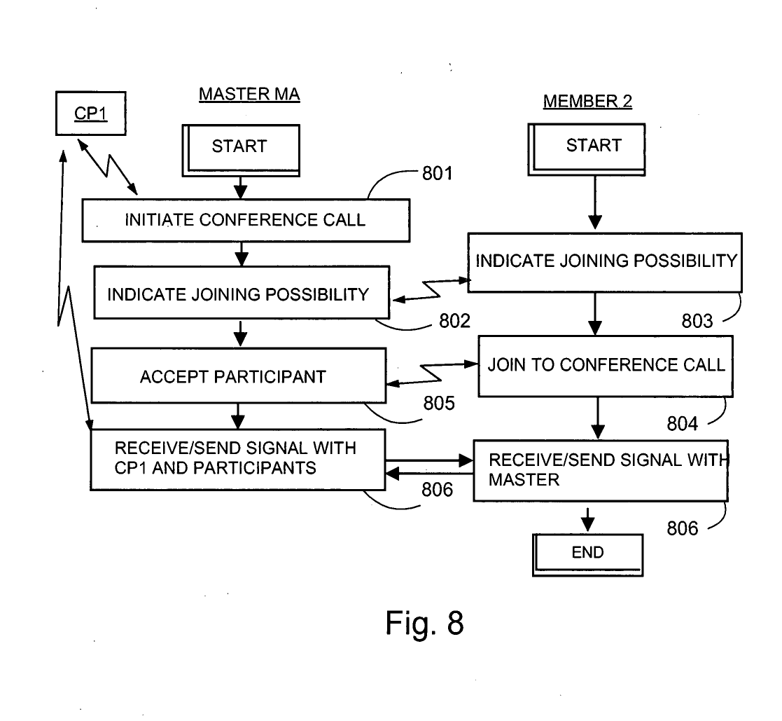

FIG. 8 shows a flowchart of the application example of the invention in connection with the conference call.

The invention describes a concept where personal portable audio devices such as mobile phones MA, MEM2-MEMn and/or also laptops may be used to organize a telephone meeting. Traditionally each meeting room AS must have a special speakerphone. The invention relies entirely on portable audio devices MA, MEM2-MEMn and short distance networks such as Bluetooth BT, WLAN (Wireless Local Area Network), etc.

FIG. 3 describes an example of a system for a conference call and FIG. 4 a rough example of devices MA, MEM2-MEMn according to the invention in their audio parts. This description refers also to the corresponding portable audio devices MEM2-MEM3 and also to base station device MA and describes their functionalities. In addition, the reference to corresponding program codes 31.1-31.6, 32.1-32.10 are also performed in suitable connections.

The system according to invention includes at least one portable audio device MEM2-MEMn and at least one base station device MA by using of which it is possible to take part to the conference call. The portable devices MEM2-MEMn are arranged in an common acoustic space AS. It may be, for example, a meeting room or some kind of that in which may occupy several conference call participants.

The devices MEM2-MEMn are equipped with audio components LS2-LSn, MIC2-MICn. The audio components of the devices MEM2-MEMn may include at least one microphone unit MIC2-MICn per device MEM2-MEMn for inputting an audible sound picked from the common acoustic space AS. In addition, the audio components may also include one or more loudspeaker units LS2-LSn per device MEM2-MEMn for outputting an audible sound to the common acoustic space AS. The side circuits of loudspeakers and microphones may also be counted to these audio components. In general, may be spoken audio facilities. In addition the devices MEM2-MEMn are equipped with at least one communication module 22. The base station unit MA may also have these above described components, of course.

At least one portable audio device MEM2-MEMn may interconnect to at least one base station device MA being in the same call. The base station device MA is also connected to the communication network CN in order to perform the conference call from the said common acoustic space AS in which the portable audio devices MEM2-MEMn and their users are.

In the invention at least part of the portable audio devices that are arranged to operate as “slaves” for the base station unit MA are surprisingly personal mobile devices MEM2-MEMn like mobile phones or laptop computers known as such. By using of the personal mobile devices MA, MEM2-MEMn is achieved the ease of use in the form of HF-mode (HandsFree). The devices MA, MEM2-MEMn may be applied as such without need, for example, wireline or wireless special devices. Also, the one or more base station MA may be such personal mobile device, such as, mobile phone, “Smartphone”, PDA-device or laptop computer, for example. The audio components MIC2-MICn of them are arranged to pick the audible sound from the common acoustic space AS (codes 31.1, 32.1).

Owing to the invention the voice quality is now very good because the microphone MIC, MIC2-MICn is close to the user. In order to get this advantage several microphones MIC, MIC2-MICn of the personal mobile devices MA, MEM2-MEMn may be used to pick the send side signal. The use of several microphones MIC, MIC2-MICn helps to reach clear voice as the send signal contains less noise and reflected speech. Variations in background noise are also minimized, as high gains are not needed for balancing of speech levels but speech level is even. In addition better near speech to echo ratio is also achieved.

Owing to the invention the voice quality is also good because also the loudspeakers LS, LS2-LSn are close to the user. The several loudspeakers LS, LS2-LSn of the personal mobile devices MA, MEM2-MEMn can be used to play the receive side signal. Especially in mobile devices the loudspeakers are limited in size and due to the physical limitations high quality sound cannot be produced at higher volume levels. The use of several loudspeakers LS, LS2-LSn limits the needed power per device making it possible to use loudspeakers of smaller audio devices. In addition, the use of several speakers LS, LS2-LSn of mobile devices MA, MEM2-MEMn help to reach even and sufficient sound pressure levels for all participants and to provide better near speech to echo ratio.

According to the one aspect of the invention, the speech enhancement functions of the send side signal are distributed to the audio devices. Typically echo and level control and noise suppression functions already exist in mobile phone type of devices and to laptop type of devices they can be added as a software component. The use of existing capabilities saves costs and the use of distributed enhancement functions helps to improve the voice quality in many ways. Now the functions can adapt to local conditions. Some examples of these are, noise of projector fan, echo control close to the microphone and level control adapts to the closest participant rather than to the active speaker.

In proximity to a participant, an audio device has substantially better near speech to echo ratio making it possible to have a duplex and echo free connection. In addition, local processing brings the echo control close to the microphone MIC, MIC2-MICn, which minimize sources of non-linearity disturbing echo cancellation. Besides the distances between microphone-loudspeaker-speaker the linearity of the echo path has effects to the operational preconditions of the echo controller. In case of non-uniform noise field, a local noise suppressor can adapt to the noise floor around the device MA, MEM2-MEMn and thereby achieve optimal functioning.

Correspondingly, level control can achieve optimal performance by taking into account local conditions such as speech and ambient noise levels. Due to the distribution of enhancements, the need for level control is lower and no re-adaptation after a change of an active speaker is needed. In proximity to a participant, the level control algorithm can discriminate between speech and background noise easier, which helps to reach accurate functioning.

The processing of the send side signal at the Sₘₐₛₜₑᵣ block of the base station device MA may consist of a simple summing junction if the short distance network BT can transfer all the microphone MIC2-MICn signals to the master MA. At minimum, the base station device MA may send only the audio signals of the personal mobile devices MEM2 of the active speaker participants USER2 to the communication network CN (code 32.6). This audio signal to be sent to the network CN may be combination of one or more microphone signals received from clients MEM2-MEMn and recognized to be active.

If all the microphone signals are not delivered to the Sₘₐₛₜₑᵣ block, the master MA needs to receive measurement information such as power in order to select dynamically at least one microphone MIC2 as an active one. Basically, the base station device MA may dynamically recognize at least one personal mobile device MEM2 of one or more active speaker participant USER2 and based on this measurement information received from the personal mobile devices MEM2-MEMn to perform the transmission of the signal of one or more active participant to the network CN (codes 31.4, 32.5). It is also possible to use a combination of these two methods so that the signal sent to the network CN includes contributions from a few microphones.

The measurement information may also be applied in order to control video camera, if that is also applied in the conference system.

According to the invention, the loudspeaker signals LS, LS2-LSn are similar or they can be made similar by applying linear system functions to them. Therefore speech enhancement functions SEFLS that modify dynamically the loudspeaker LS, LS2-LSn signal occur mainly on the master device MA. In general, the speech enhancement functions SEFLS concerning loudspeaker LS2-LSn signals intended to be outputted by the loudspeakers of the personal mobile devices MEM2-MEMn and possible also via the loudspeaker LS of the master device MA are mainly arranged and the corresponding actions are performed in connection with the base station device MA (code 32.2).

These operations of the loudspeaker LS and LS2-LSn signal may include, for instance, noise suppression and level control of the receive side signal. The use of common loudspeaker signals LS, LS2-LSn makes it possible to cancel the echo accurately using a linear echo path model also in multi loudspeaker systems. Otherwise the system must resolve a complex multi channel echo cancellation problem or accept a lower ERLE value. Otherwise the system must resolve a complex multi channel echo cancellation problem, leading to challenging Multiple Input Multiple Output (MIMO) system configuration, or accept a lower ERLE value.

The invention can be implemented by software 31, 32. In case of mobile phones the invention may utilize GSM, Bluetooth, voice enhancement, etc. functions without increasing computing load. In case of other audio devices such as laptops, the invention may use the existing networking and audio capabilities and additional voice processing functions can be added as a software component running on the main processor.

The connection between the masters MA and members MEM2-MEMn interconnected to that and also between the masters MA and the one or more counterparties CP1/2/3 . . . may be some widely available, possible wireless and easy to use, but from the invention point of view, for example, fixed telephone or IP connections could be used as well. Correspondingly, the short distance network BT may be some easily available for the local participants. Automatic detection of available audio devices MA, MEM2-MEMn makes it possible to gather the local group easily and securely using for instance steps explained in the later chapters. The implementation described below is based on Bluetooth capable GSM phones MA, MEM2-MEMn.

FIG. 5 illustrates the voice processing functions in a multi-microphone and -speaker system consisting of three audio devices called Master MA, Member2 MEM2 and Member3 MEM3. Rₘₐₛₜₑᵣ block handles voice processing of the receive side signal common to all audio devices MA, MEM2, MEM3. In this implementation, Rₘₐₛₜₑᵣ suppress background noise present in the receive signal. Audio device specific processing of the receive side signals occurs in R1-R3 blocks in each devices MA, MEM2, MEM3 to which the received side signal is directed. The TRᵣ blocks between the Rₘₐₛₜₑᵣ and R2-R3 blocks illustrate the transmission from the Master MA to the Member2 and Member3 audio devices MEM2, MEM3.

At minimum, the TRᵣ blocks may delay the signal. If speech compression is applied during the transmission, TRᵣ blocks include coding and decoding functions COD, DEC run on master MA and Member2 and 3 MEM2, MEM3, correspondingly. If both long and short distance signals shall be compressed, the additional transcoding may be avoided by using the same codec. In general, the audio signal intended to be outputted by the loudspeakers LS2-LSn of the personal mobile devices MEM2-MEMn is arranged to be sent by the base station device MA to the personal mobile devices MEM2-MEMn as such without audio coding operations on the master device MA and the said audio coding operations are arranged to be performed only in connection with the personal mobile devices MEM2-MEMn when it is received the audio signal (codes 31.5, 32.7). Other option is to decode the signal in the base station MA and send that to the client devices MEM2, MEM3 in order to play without any audio coding measures.

The blocks E1-E3 in FIG. 5 illustrate the echo coupling from the three loudspeakers LS, LS2, LS3 to the microphone MIC3 of member3 MEM3. The loudspeakers LS, LS2, LS3 are not presented in FIG. 5 but their correct place would be after blocks R1-R3. In the invention at least part of the personal mobile devices MEM2-MEMn are arranged to output the audible sound to the common acoustic space AS by using of their audio components LS2-LSn (codes 31.3, 32.3). The blocks E1-E3 can be modelled by an FIR (Finite Impulse Response) filter. The blocks E1-E3 model both the direct path from the loudspeakers LS, LS2, LS3 to the microphone MIC3 and the indirect path covering reflections from walls etc. For simplicity, echo paths ending to the Master MA and Member2 MEM2 microphones MIC, MIC2 are omitted from the FIG. 5.

Audio device specific processing of the send side signals occurs in S1-S3 blocks. Basically, the microphone MIC, MIC2, MIC3 signals produced by the personal mobile devices MA, MEM2-MEM3 from the audible sound picked from the common acoustic space AS is processed by the speech enhancement functions SEF2MIC-SEFnMIC of the personal mobile device MA, MEM2-MEMn (codes 31.2, 32.4). These enhancement functions may be merged in connection with blocks S1-S3.

In this implementation, S1-S3 blocks i.e. the speech enhancement functions according to the invention may contain echo and level control and noise suppression functions SEF2MIC, SEF3MIC. The TRₛ blocks between the S2-S3 blocks and Sₘₐₛₜₑᵣ illustrate the transmission from member2 and 3 MEM2, MEM3 to master MA.

Again, at minimum, the TRₛ blocks may delay the signal. If speech compression is applied during the transmission, TRₛ blocks include coding and decoding functions COD, DEC. In this implementation, Sₘₐₛₜₑᵣ sums the three signals one of its own and two received from the clients MEM2, MEM3 and sends the signal to the distant master(s) of one or more counterparties CP1/2/3 via communication network CN.

In general, echo control blocks S1-S3 need two inputs. The first input contains the excitation or reference signal and the second input contains the near-end speech, the echoed excitation signal and noise. As an example, the echo control of Member3 MEM3 may be observed. As a reference input it uses the receive side signal which the master MA transmits trough the TRᵣ block. The receive side signal is not necessarily needed to be inputted to all loudspeakers but, however, it must in any case relay to every echo cancellers SEF2MIC, SEF3MIC as a reference signal. The signal of the microphone MIC3 forms the other input. It consists of near speech, noise and E1-E3 echo components.

Because the TRᵣ block delays the reference signal that is mainly caused by the transferring of the audio signal over the radio link BT, it is possible that the reference signal reaches member3 MEM3 after the E1 echo component. This would make it impossible to cancel the echo.

In this implementation the receive signal is delayed in the R1 block before it is fed to the master's MA loudspeaker LS. In addition, the signal between S1 and Sₘₐₛₜₑᵣ is also delayed DL. In general, the audio signal may be delayed in connection with the one or more devices MA (code 32.8). The delay DL in receive side signal compensates the delay in the TRᵣ block that is caused mainly by, for example, transferring of the audio signal over the radio link BT. This enables proper echo control and results in better voice quality as all loudspeaker LS, LS2, LS3 signals are now played simultaneously having thus similar timing. It would be possible to resolve the echo control problem by delaying member3 MEM3 microphone MIC3 signal, but in that case the loudspeaker LS, LS2, LS3 signals of the master MA and members2 and 3 MEM2, MEM3 would not occur simultaneously. In addition, the delay on the send direction would increase. Correspondingly, the timing difference due to the send side TRₛ blocks can be balanced before the signals are combined in the Sₘₐₛₜₑᵣ block. Delay DL performed in master MA between S1 and Sₘₐₛₜₑᵣ-block compensates this delay in send side signal that is received from clients over radio link BT. The delays may be estimated, for example, from the specifications of the utilized network. The delays are also possible to measure, for example, based on the known cross-correlation methods.

If lossy compression is applied in the TRᵣ blocks, the master MA and the members MEM2, MEM3 will receive a different receive side signal. If it is considered again the echo control of member3 MEM3 as an example, it may be observed that if the R1 block receives the input inᵣ₁=receive′, the R2-R3 blocks receive the input in_{R23}=decode(code(receive′)). The echo control cannot model the output of the E1 block accurately by using a linear echo path model and the reference input decode(code(receive′)). This reduces the ERLE achievable by linear adaptive techniques. Therefore, in this implementation, also the master MA uses the decoded receive side signal so that all audio devices MA, MEM2, MEM3 will have similar loudspeaker LS, LS2, LS3 and echo control reference inputs.

Audio device specific dynamic processing of the receive side signal would introduce a similar effect. Therefore functions such as noise suppression are performed in the Rₘₐₛₜₑᵣ block and dynamic processing in blocks R1-R3 is avoided. Correspondingly, non-linearities on the path from a microphone MIC, MIC2, MIC3 to an echo control reduce the ERLE achievable by linear adaptive techniques. For instance transmission errors, lossy compression or limited dynamics reduce the linearity. The lower the ERL and the level of the near speech are, the higher are the requirements for the linearity of the microphone path. In this implementation, the distribution of echo control to the S1-S3 blocks minimizes the length of the microphone path and thereby source of non-linearities on the echo path.

The implementation can be modified in many ways. For example, the need of delay compensation can be reduced or avoided by disabling the loudspeaker LS and/or microphone MIC of the master device MA. It is not necessary at all to equip the master MA with these output and input components LS, MIC. It is also possible to use only few or one loudspeaker. In such case, the coupling of echo can be reduced if the microphones MIC2 and loudspeakers LS3 locate in separate devices MEM2, MEM3.

The base station functionality may be partly in the communication network CN, too. Some examples of these networked functionalities are, selection of the active speaker and/or transmission to the counter part CP1.

Yet, one other embodiment is the hierarchical combining of the microphone signal. Owing to this is achieved elimination of the limitations of the local network BT. In this embodiment the system includes several master devices in which they may send and receive signals from other master devices forming a hierarchical network having, for example, a tree structure.

More particularly, in this embodiment the master devices MA are equipped with appropriate control means (code 32.10) for the distribution of a common received signal to all connected devices. Such control means can be implemented in different ways. For example, it is possible to control the speech enhancement functions SEFLS preventing or bypassing repeated SEFLS processing or alternatively implement the SEFLS so that repeated processing does not cause significant changes to the signal in repeated processing.

The hierarchical connection can be applied to increase the total number n of devices connected with a short distance connection BT in case the maximum number of devices would be limited by the processing capacity of the one master device MA or the maximum number of short distance network connections (BT, WLAN, etc.) one master device MA.

According to one more embodiment different kind of local area networks (BT/WLAN) is also possible to apply even concurrently.

It is easy to widen the scope of the invention. For instance, the master device MA could send a video signal to the far-end participants CP1 and broadcast the receive side video signal to the local members MEM2, MEM3. The selection of the active participant (camera) could be automatic and it could be based on audio information. In case of other visual information such as slides the source could be selected independently on the audio signal.

The success of mobile phones has shown that people appreciate mobility. Owing to the invention, telephone meetings can now be arranged anytime and anywhere, for instance in hotel rooms or in vehicles. Arranging of a conference call is as easy as dialling of a normal call by the phone's address book. In many respects, voice quality and mobility set contradictory requirements to the conference call equipment. For instance, to provide an adequate sound pressure level for all participants, one should have a relatively large loudspeaker. In mobile use, the size of devices need to be minimized. For instance, in mobile phones the size of a loudspeaker may be less than 15 mm, and due to physical limitations, such a small loudspeaker cannot serve a whole meeting room.

The invention describes a distributed conference audio functionality enabling the use of several hands free terminals MA, MEM2-MEMn in same acoustic space AS. In the invention the system includes a network of microphones MIC, MIC2-MICn, loudspeakers LS, LS2-LSn and distributed enhancements SEFLS, SEFMIC, SEF2MIC-SEFnMIC.

A conference call is now also possible in noisy places such as in cars or in places where the use of a loudspeaker is not desirable if people are using their phones in handset or headset mode.

Owing to the invention the conference call is now as easy as dialling of a normal phone call by the phone's MA address book 23.

Conference calls according to the invention are also economical. Neither expensive operator services nor additional pieces of equipment are needed anymore. In addition to the business also new user groups may adopt conference calls. The mobile personal devices, such like mobile phones have already the needed networking and audio functions.

A telephone meeting according to the invention is described in FIG. 8 and it might go as follows. Stages relating to speech inputting, processing and outputting are described already prior in the description in suitable connections and these all are here included to the stage 806.

One (or more) user(s) (master(s)) may call to a member of the distant group CP1 and selects “conference call” from the menu of her or his device MA (stage 801). There may be one or more distance groups in which there are one or more participants. Other members MEM2-MEMn of the local group see a “conference call” -icon on their display DISP that is indicated be the master MA and they may press an OK-key of the keypad 35 of their device MEM2-MEMn (stages 802, 803). In stage 804 the members join to call an in stage 805 the master MA accepts the local members MEM2-MEMn by a keystroke. In order to deal out these stages (indicating, joining and accepting) the devices MA, MEM2-MEMn may be equipped by code means 31.6, 32.9.

Fixed or wireless telephone or data connection is used between the masters MA, CP1 of the groups. In order to deal out this connection master MA is equipped with GSM-module 33. Preferable, a Bluetooth connection BT or other short distance radio link is used between the master MA and the local members MEM2-MEMn. In order to deal out this connection master MA and participants MEM2-MEMn are equipped with Bluetooth-modules 24, 22. The master MA uses the short distance network to broadcast the receive side signal to the local participants MEM2-MEMn. The local audio devices MEM2-MEMn spreaded to the acoustic space AS send the microphone MIC2-MICn signals to the master MA, which processes the data and transmits the send side signal to the distant master CP1 by GSM-module 33 (stage 806). It should be noted that for every participant is not needed to arrange personal audio device. It is also possible that several participants are around one device. In addition, that is also possible that some of the participants are equipped with BT headset instead of personal audio device.

The most appropriate way of transferring of the local signals depends on the number of local members MEM2-MEMn and capabilities of the short distance network BT. Bluetooth BT, for instance, is capable of supporting three synchronous connection oriented links that are typically used for voice transmission. There are also asynchronous connectionless links (ACL) that are typically used for data transmission. In addition, to point-to-point transfers, ACL links support point-to-multipoint transfers of either asynchronous or isochronous data.

For the skilled person it is obvious that at least part of the functions, operations and measures of the invention may be performed in a program level executed by the processor CPU1, CPU2. Of course, the implementations in which part of the operations are performed on program level and part of the operations are performed on the hardware level, is also possible. Next in the relevant points are referred to these program code means by means of which the device operations may be performed according to one embodiment. The program code means 31.1-31.6, 32.1-32.10 forming the program code means 31, 32 are presented in FIGS. 6 and 7.

In FIGS. 6 and 7 are presented the rough schematic views of the application examples of the program products 30.1, 30.2 according to the invention. The program products 30.1, 30.2 may include memory medium MEM, MEM′ and a program code 31, 32 executable by the processor unit CPU1, CPU2 of the personal mobile device MEM2 and/or base station device MA and written in the memory medium MEM, MEM′ for performing conference call and the operations in accordance with the system and the method of the invention at least partly in the software level. The memory medium MEM, MEM′ for the program code 31, 32 may be, for example, a static or dynamic application memory of the device MEM2, MA, wherein it can be integrated directly in connection with the conference call application or it can be downloaded over the network CN.

The program codes 31, 32 may include several code means 31.1-31-6, 32.1-31.9 described above, which can be executed by processor CPU1, CPU2 and the operation of which can be adapted to the system and the method descriptions just presented above. The code means 31.1-31.6, 32.1-32.10 may form a set of processor commands executable one after the other, which are used to bring about the functionalities desired in the invention in the equipment MEM2, MA according to the invention. One should also understand that there may be both program codes in the same device, that is not excluded in any way.

The distance of the loudspeaker from the participants isn't necessary as critical as the distance of the microphone from the participants if it is possible to compensate the distance by use of more effective components.

It should be understood that the above specification and the figures relating to it are only intended to illustrate the present invention. Thus, the invention is not limited only to the embodiments presented above or to those defined in the claims, but many various such variations and modifications of the invention will be obvious to the professional in the art, which are possible within the scope of the inventive idea defined in the appended claims.

1-57. (canceled)

58. System for a conference call, which includes
at least one portable audio device arranged in an common acoustic space which device is equipped with audio components for inputting and outputting an audible sound and at least one communication module,
at least one base station device to which at least the said one portable audio device is interconnected and which base station device is connected to the communication network in order to perform the conference call from the said common acoustic space,
characterized in that at least part of the portable audio devices are personal mobile devices which audio components are arranged to pick the audible sound from the said common acoustic space.

59. Portable audio device for a conference call, which is equipped with audio components for inputting and outputting an audible sound from a common acoustic space and at least one communication module in order to be interconnected with at least one base station device that is connected to the communication network in order to perform the conference call from the common acoustic space, characterized in that the portable audio device is a personal mobile device which audio components are arranged to pick the audible sound from the said common acoustic space.

60. Portable audio device according to claim 59, characterized in that the audio components include a microphone for inputting an audible sound picked from the common acoustic space and a loudspeaker for outputting an audible sound to the common acoustic space and microphone signal produced by the personal mobile device from the audible sound picked from the common acoustic space is arranged to be processed by the speech enhancement functions of the said personal mobile device.

61. Portable audio device according to claim 60, characterized in that the speech enhancement functions include at least echo cancellation to which is arranged to be inputted as a reference signal the receive side signal received from base station device.

62. Portable audio device according to claim 59, characterized in that the personal mobile device is arranged to send measurement information to the base station device in order to recognize dynamically the personal mobile device of one or more active speaker participant.

63. Portable audio device according to claim 60, characterized in that the said base station device is also at least partly arranged to the said common acoustic space and the audio signal intended to be outputted by the loudspeaker of the personal mobile device is arranged to be received from the base station device as such without audio coding operations and the said audio coding operations are arranged to be performed in connection with the personal mobile device.

64. Base station device for conference call system that is arranged at least partly to a common acoustic space and which base station device is equipped with possible audio components for inputting and outputting an audible sound and to which at least part of the portable audio devices are interconnected as clients and which base station device is connected to the communication network in order to perform the conference call from the said common acoustic space, characterized in that the said base station device is a personal mobile device which audio components are arranged to pick the audible sound from the said common acoustic space.

65. Base station device according to claim 64, characterized in that the audio components include a microphone for inputting an audible sound picked from the common acoustic space and a loudspeaker for outputting an audible sound to the common acoustic space and microphone signal produced by the base station device from the audible sound picked from the common acoustic space is arranged to be processed by the speech enhancement functions of the said base station device.

66. Base station device according to any of claims 64, characterized in that the base station device is dynamically arranged to recognize at least one portable audio device of the one or more active speaker participant based on the measurement information received from the portable audio devices.

67. Base station device according to claim 66, characterized in that the base station device is arranged to send only the audio signals of the portable audio devices of the active speaker participants to the communication network.

68. Base station device according to claim 65, characterized in that the speech enhancement functions concerning the loudspeaker signals are mainly arranged in connection with the base station device.

69. Base station device according to claim 65, characterized in that the audio signal intended to be outputted by the loudspeakers of the portable audio devices is arranged to be sent by the base station device to the portable audio devices as such without audio coding operations.

70. Base station device according to claim 65, characterized in that the loudspeaker signal is arranged to be delayed in connection with the base station device in order to achieve loudspeaker signals having similar timing.

71. Base station device according to claim 64, characterized in that the base station device is arranged to be connection with at least one other base station device which base station devices are arranged to send and receive signals from other base station devices forming a hierarchical network in order to distribute the signal between the personal mobile devices.

72. Method for performing a conference call, in which
at least one portable audio device arranged in an common acoustic space which device is equipped with audio components for inputting and outputting an audible sound and at least one communication module,
at least one base station device to which at least the said one portable audio device is interconnected and which base station device is connected to the communication network in order to perform the conference call from the said common acoustic space,
characterized in that at least part of the portable audio devices are personal mobile devices which audio components are arranged to pick the audible sound from the said common acoustic space.

73. Method according to claim 72, characterized in that the audio components include a microphone for inputting an audible sound picked from the common acoustic space and a loudspeaker for outputting an audible sound to the common acoustic space and microphone signal produced by the personal mobile device from the audible sound picked from the common acoustic space is processed by the speech enhancement functions of the said personal mobile device.

74. Method according to claim 73, characterized in that the speech enhancement functions include at least echo cancellation to which is inputted as a reference signal the receive side signal received from base station device.

75. Method according to claim 72, characterized in that the base station device is dynamically recognized at least one personal mobile device of one or more active speaker participant based on the measurement information received from the personal mobile devices.

76. Method according to claim 72, characterized in that the base station device is sent only the audio signals of the personal mobile devices of the active speaker participants to the communication network.

77. Method according to claim 73, characterized in that the speech enhancement functions concerning loudspeaker signals are mainly proceeded in connection with the base station device.

78. Method according to claim 73, characterized in that the said base station device is also at least partly arranged to the said common acoustic space and the audio signal intended to be outputted by the loudspeakers of the personal mobile devices is sent by the base station device to the personal mobile devices as such without audio coding operations and the said audio coding operations are performed in connection with the personal mobile devices.

79. Method according to claim 73, characterized in that the loudspeaker signal is delayed in connection with the one or more devices in order to achieve loudspeaker signals having similar timing.

80. Method according to claim 72, characterized in that several base station devices are arranged to send and receive signals from other base station devices forming a hierarchical network in order to distribute the signal between the personal mobile devices.

81. Program product for performing a conference call client device functionality that is intended to be interconnect to a base station device, which program product include a storing means and a program code executable by processor and written in the storing means, characterized in that the program code is arranged in connection with a personal mobile device that is equipped with audio components including a microphone and a loudspeaker and which program code includes
first code means configured to pick an audible sound from an common acoustic space by using of the microphone of the said personal mobile device and
second code means configured to process the microphone signal produced from the audible sound by the speech enhancement functions of the personal audio device.

82. Program product for performing a conference call base station functionality for at least one portable audio device, which program product include a storing means and a program code executable by processor and written in the storing means, characterized in that at least part of the program code is arranged in connection with a personal mobile device that is equipped with a possible loudspeaker and a microphone and which program code includes
first code means configured to pick an audible sound from an common acoustic space by using of the microphone of the said base station device and
second code means configured to process the loudspeaker signals intended to be outputted by the loudspeakers of the portable audio devices by the speech enhancement functions of the base station device.
